(19) United States
(12) Patent Application Publication
(10) Pub. No.: US 2022/0314110 A1
(43) Pub. Date: Oct. 6, 2022

(54) Opto-Mechanical Human Interface Analog Input Device Based on a Reflective Proximity Processing Method

(71) Applicants: Andrey Zheleznov, Dongguan (CN); Steven Mar, Pomona, CA (US)

(72) Inventors: Andrey Zheleznov, Dongguan (CN); Steven Mar, Pomona, CA (US)

(21) Appl. No.: 17/220,766

(22) Filed: Apr. 1, 2021

(51) Int. Cl. A63F 13/218; G01S 17/32; A63F 13/24

(52) U.S. Cl. CPC A63F 13/218; G01S 17/32; A63F 13/24

(57) ABSTRACT

An analog signal measurement apparatus and system that utilize light optics to trigger button input commands when the button is pressed or activated. A light beam from an infrared light emitting diode is adapted to enable users to operate electronic equipment with limited physical interaction with the equipment surfaces. Embodiments of the invention utilize a non-contact analog signal measurement that occurs with a beam of light from an infrared emitting diode is directed inside a hollow tube towards a piston that moves in and out of the tube. The beam is reflected towards an infrared receiving diode, which connects to an analog sensor that calculates the delay and beam intensity in order to determine the proximity of the piston. In embodiments, the piston is a spring-loaded structure with a leading centrally placed rod that does not obstruct the beam of light and is connected to the analog trigger button on the other end which recedes into the hollow tube when the user presses a trigger button.

### BACKGROUND OF THE INVENTION

### 1. Field of the Invention

The present invention is directed to signal measurement apparatus and systems that utilize proximity processing algorithms derived from a reflected light beam to activate or trigger input commands when a button is pressed or activated for use in various input systems.

### 2. Description of the Related Art

Conventional analog and digital buttons used in electronic equipment rely primarily on electromechanical structures to activate or trigger input commands. These conventional structures are prone to structural stress and erosion of the resistance layer in the potentiometer or tactile switch. Actual physical destruction can occur when excessive force is applied such as with video game controllers.

A majority of input mechanism failures arise from these disadvantages which drives companies to implement various conventional non-contact solutions such as Hall sensors, using magnetic proximity, or graphite-enabled PCBs. Such conventional non-contact solutions have certain disadvantages such as high cost, the necessity to calibrate control circuits and environment-driven inaccuracies.

There is a need for inexpensive, reliable apparatus and systems that do not rely on friction parts or electromechanical structures to operate an electronic device while also maintaining high precision and accuracy, longer performance and better service life.

### SUMMARY OF THE INVENTION

The inventive concepts described herein address and solve the problems with conventional analog and digital button solutions used in electronic equipment. The present invention allows for discriminated repeated input by a user, i.e., quickly and repeatedly pushing a button with a varied force, with a high accuracy and while decreasing potential erosion and mechanism degradation due to friction and extended use.

The invention utilizes a beam of focused light within an enclosed chamber. An embodiment of the invention provides for a non-contact analog measurement that occurs by using a beam of light from an infrared light emitting diode within a tube. The light is directed towards a piston that moves in and out of the tube. The beam is then redirected towards an infrared light receiving diode by the piston. The infrared receiving diode connects to an analog sensor that calculates the delay and beam intensity in order to determine the proximity of the piston. This information is used to activate the desired input command or commands.

The piston is a spring-loaded structure with a leading rod arranged in the middle so the rod does not obstruct the beam of light. The piston and rod are connected to a trigger button so that the piston and rod recede into the tube when a user presses the trigger button.

This system can be incorporated into an electronic device at a much lower cost than conventional non-contact solutions. The invention advantageously allows for extreme precision and the ability to use as many increments as necessary, high durability not impacted by ambient temperature, reduced mechanical stress and fatigue on the sensor parts, improved or automatic calibration on power-up and substantially longer effective service life. Further advantages and embodiments of the invention will be apparent to persons skilled in the art from the drawings and description set forth herein.

### BRIEF DESCRIPTION OF THE DRAWINGS

FIG. 1 illustrates one embodiment of the invention implemented in a video game controller.

FIG. 2 illustrates an embodiment of the invention showing a tube and a trigger button.

FIG. 3 illustrates an exploded diagram of an embodiment of the invention.

FIG. 4 is a front view of a trigger button, piston and rod in one embodiment.

FIG. 5 is a view of parts in one embodiment.

FIG. 6 illustrates a section view of an embodiment of the invention taken along Line 6-6 in FIG. 1 with arrows to illustrate this embodiment.

FIG. 7 illustrates a section view of the embodiment shown in FIG. 6 with arrows to further illustrate this embodiment.

FIG. 8 is a section view of another embodiment of the invention taken along Line 8-8 in FIG. 1 with arrows to illustrate this embodiment.

FIG. 9 is a section view of the embodiment shown in FIG. 8 with arrows to further illustrate this embodiment.

FIG. 10 illustrates an infrared emitter and an infrared receiver for use in one embodiment of the invention.

FIG. 11 shows an exemplary level discriminating circuitry for use in one embodiment of the invention.

FIG. 12 is an illustrative graph to demonstrate one embodiment of the invention.

### DETAILED DESCRIPTION OF EMBODIMENTS OF THE INVENTION

Reference is made to the Figures in which elements of the illustrated embodiments of the invention are given numerical designations so as to enable one skilled in the art to make and use the invention. It is understood that the following description is exemplary of embodiments of the invention and it is apparent to skilled persons that modifications are possible without departing from the inventive concepts herein described.

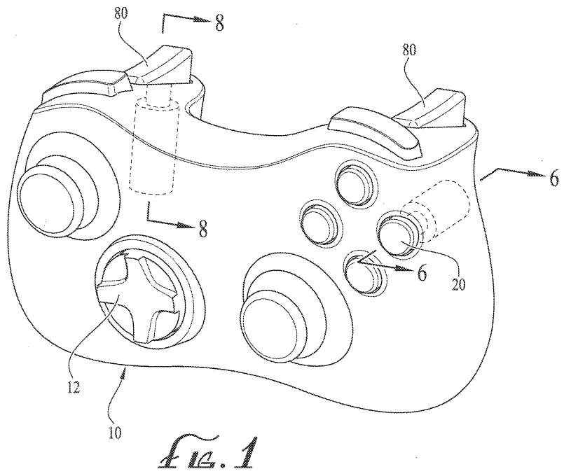

Referring to FIG. 1, embodiments of the invention are incorporated into what is commonly known in the art as a video game controller 10. The video game controller 10 may include conventional analog mechanical control knobs 12 and include embodiments of the invention that include one or more trigger buttons 20 and shoulder buttons 80.

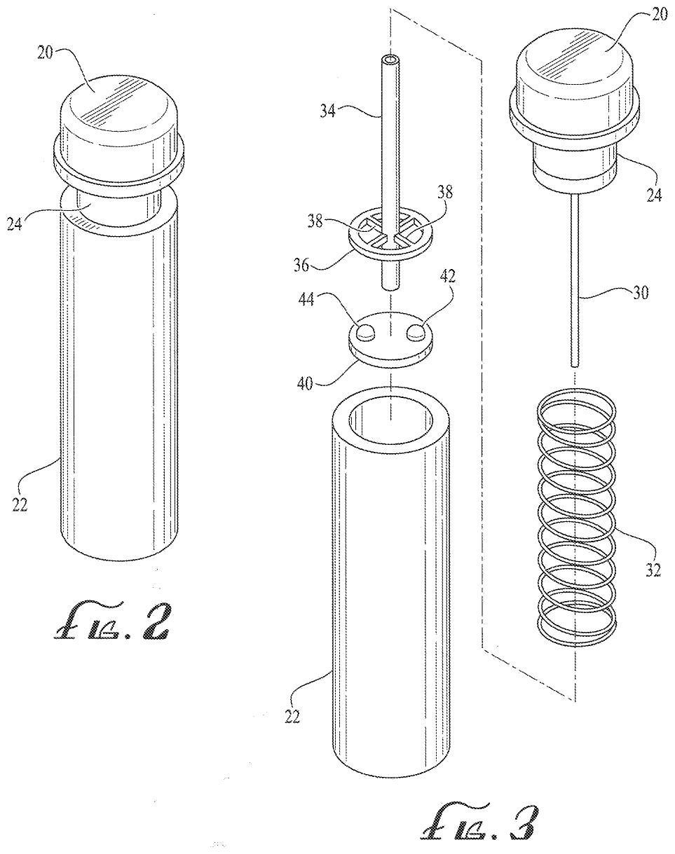

In one embodiment illustrated in FIG. 2, the trigger button 20 includes a piston 24 and an adjacent tube 22. The tube 22 is sized to accommodate the piston 24 so that the piston 24 is selectively displaced in a plurality of positions within the tube 22 limited by the configuration of the trigger button 20 as shown in the Figures.

FIG. 3 illustrates an exploded view of an embodiment with the piston 24 shown secured to the rod 30. A spring 32 shown in FIG. 3 is placed around the rod 30 and adjacent to the piston 24. In embodiments of the invention, the spring 32 is a biasing spring and a metallic spring with various damping and/or bouncing properties can be utilized depending on the required parameters and properties of the end mechanism. The spring 32 is sized to fit within the interior of the tube 22 as illustrated in the Figures.

The rod 30 is removably and slidably secured within the rod sleeve 34 as illustrated in FIG. 3. The rod sleeve 34 includes the spring bumper 36 which is secured to the rod sleeve 34. As shown in the embodiment in FIG. 3, the spring bumper 36 includes cross bars 38 to allow for an open configuration of the spring bumper 36 although other configurations of the spring bumper 36 that include an open configuration or apertures are within the scope of the invention. The rod sleeve platform 40 is placed adjacent to the end of the rod sleeve 34 as shown in FIG. 3. The rod sleeve platform 40 includes light emitter 42 and light receiver 44 arranged on the platform 40 as shown in FIG. 3.

In embodiments of the invention, light emitter 42 is a common through-hole mounted infrared light-emitting diode, wavelength 940 nm, diameter 3 mm. In embodiments of the invention, the light receiver 44 is a common through-hole mounted infrared phototransistor or photodiode, with a matching wavelength of 940 nm and a diameter of 3 mm isolated on its side with heat-shrink or other similar coating material to expose only the top part.

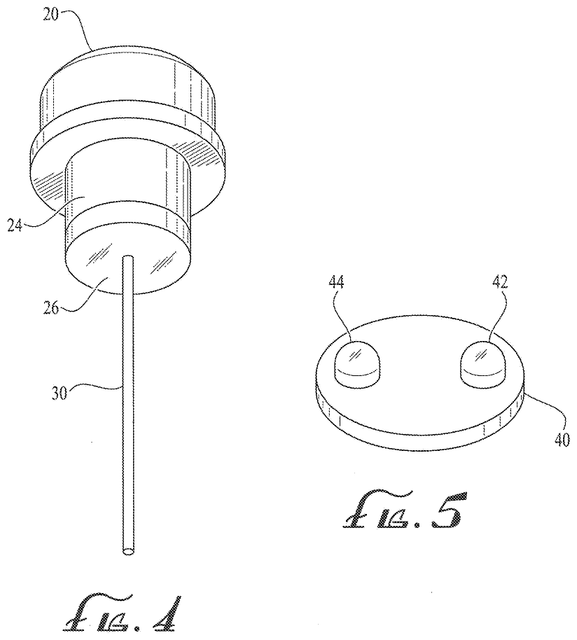

FIG. 4 illustrates a side view of an embodiment of the invention with the trigger button 20 having the piston 24 and the rod 30. The piston 24 includes reflecting surface 26 as shown in FIG. 4. In embodiments, as an example the reflecting surface 26 may be made by either plastic such as polycarbonate or a metal with advantageous optical properties.

FIG. 5 illustrates an embodiment of the rod sleeve platform 40 with the light emitter 42 and the light receiver 44 attached to the platform 40.

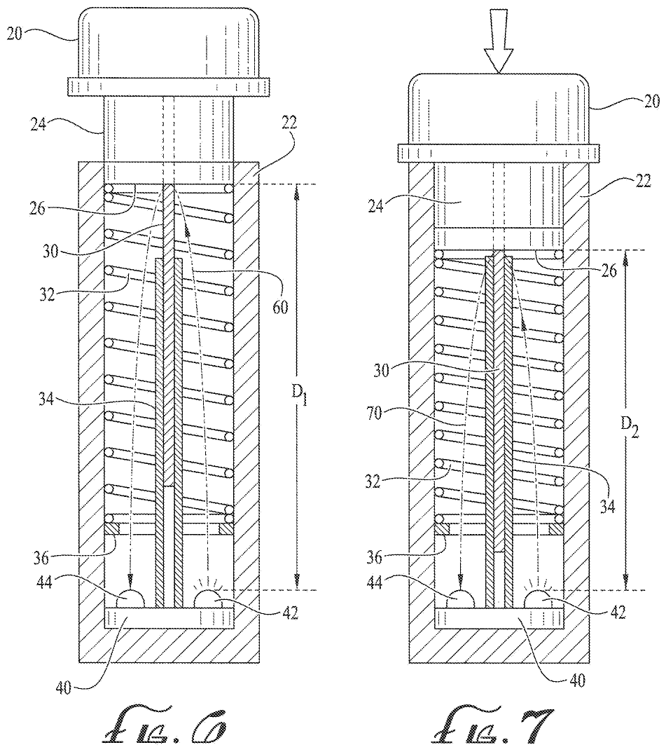

FIG. 6 illustrates a cross section view of one embodiment. The trigger button 20 with the piston 24 is adjacent to the tube 22. As shown in FIG. 6, the spring 32 is placed within the tube 22 and in this embodiment, the spring 32 biases the piston 24 and thus the trigger button 20 away from the tube 22. The piston 24 is secured to the rod 30 and the rod 30 is partially within the rod sleeve 34. The spring bumper 36 is placed within the tube 22 and contacts the spring 32 as shown in FIG. 6. The rod sleeve platform 40 with the light emitter 42 and light receiver 44 are secured within the tube 22.

In this embodiment, light illustrated by the dashed line 60 in FIG. 6, is emitted from the light emitter 42 toward the reflecting surface 26 and then reflected toward the light receiver 44 also as illustrated by dashed line 60. The light receiver receives the light (dashed line 60). The spring 32 and spring bumper 36 are arranged within the tube 22 to not interfere with the light as shown in FIG. 6.

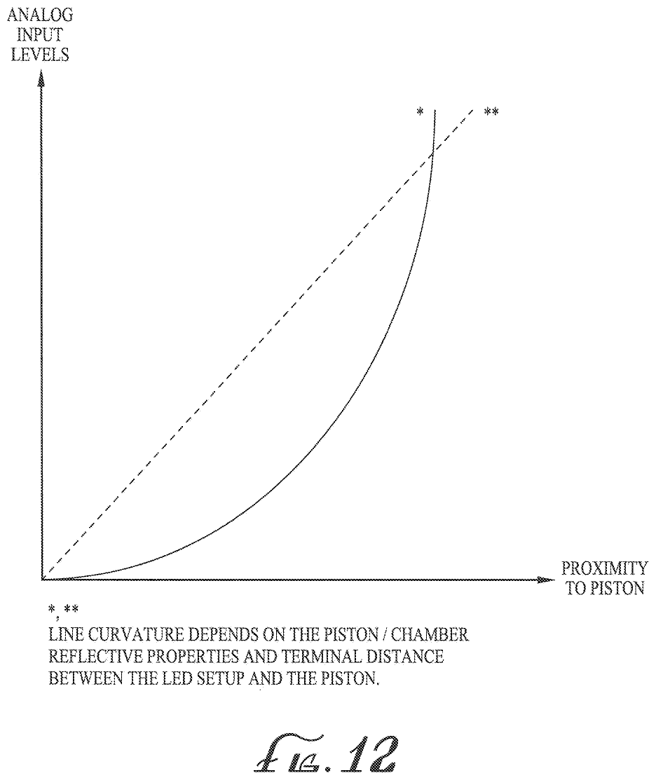

The light receiver 44 is connected to an analog sensor that calculates the delay and beam intensity to determine the piston location or distance illustrated as D1 in FIG. 6. The entire setup then acts as an analog button with one input (supplying voltage to the emitting diode), one output (reading reflected analog values at the receiving diode or transistor), and ground (three-wire design) that provide impedance analog readings in the range of a variable resistor (potentiometer) depending on the proximity of the piston 24. The circuit board can be designed on a circular piece of standard PCB material, with either a transistor or operational amplifier key for calibrated (discriminated) readings, or directly as a setup of three aforementioned wires for unfiltered output. Exemplary embodiments are illustrated in FIG. 10 and FIG. 11

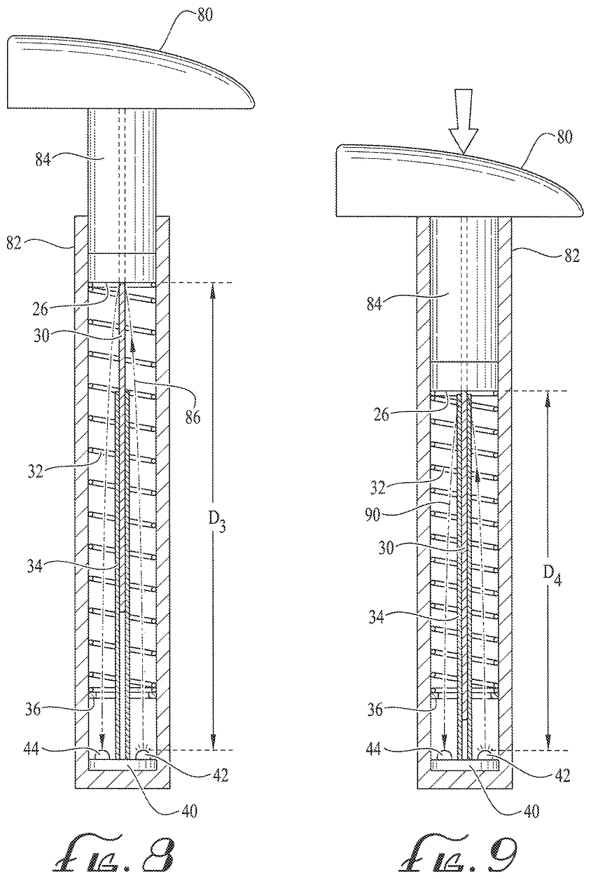

FIG. 7 illustrates another cross section view of the embodiment in FIG. 6. The trigger button 20 with the piston 24 is adjacent to the tube 22. The spring 32 is placed within the tube 22 and in this embodiment, the spring 32 is compressed by the user activating or pushing the trigger button 20 (shown by the arrow in FIG. 7) to displace the piston 24 a distance within the tube 22.

As shown in FIG. 7, the piston 24 is secured to the rod 30 and the rod 30 recedes further within the rod sleeve 34. The spring bumper 36 is placed within the tube 22 and contacts the spring 32 as shown in FIG. 7. The rod sleeve platform 40 with the light emitter 42 and light receiver 44 are secured within the tube 22.

In this embodiment, light illustrated by the dashed line 70 in FIG. 7, is emitted from the light emitter 42 toward the reflecting surface 26 and then reflected toward the light receiver 44 also as illustrated by dashed line 70. The light receiver receives the light (dashed line 70). The spring 32 and spring bumper 36 are arranged within the tube 22 to not interfere with the light as shown in FIG. 7.

The light receiver 44 is connected to an analog sensor that calculates the delay and beam intensity to determine the piston location or distance illustrated as D2 in FIG. 7. Shorter distance D2 results in higher intensity of reflect light, which results in greater analog readings on the receptable or receiving piece of the setup that incrementally grow as the distance becomes shorter and conversely, recede as the piston 24 is moved further away. This is illustrated graphically in a general manner in FIG. 12.

FIG. 8 illustrates a cross section view of a further embodiment of the invention. The shoulder trigger button 80 with the piston 84 is adjacent to the tube 82. As shown in FIG. 8, the spring 32 is placed within the tube 82 and in this embodiment, the spring 32 biases the piston 84 and thus the shoulder trigger button 80 away from the tube 82. The piston 84 is secured to the rod 30 and the rod 30 is partially within the rod sleeve 34. The spring bumper 36 is placed within the tube 82 and contacts the spring 32 as shown in FIG. 8. The rod sleeve platform 40 with the light emitter 42 and light receiver 44 are secured within the tube 82.

In this embodiment, light illustrated by the dashed line 86 in FIG. 8, is emitted from the light emitter 42 toward the reflecting surface 26 and then reflected toward the light receiver 44 also as illustrated by dashed line 86. The light receiver receives the light (dashed line 86). In this embodiment, the spring 32 and spring bumper 36 are arranged within the tube 22 to not interfere with the light as shown in FIG. 8.

The light receiver 44 is connected to an analog sensor that calculates the delay and beam intensity to determine the piston location or distance illustrated as D3 in FIG. 8. In this embodiment, the arrangement then acts as an analog button with one input (supplying voltage to the emitting diode), one output (reading reflected analog values at the receiving diode or transistor), and ground (three-wire design) that provide impedance analog readings in the range of a variable resistor (potentiometer) depending on the proximity of the piston 84. The circuit board can be designed on a circular piece of standard PCB material, with either a transistor or operational amplifier key for calibrated (discriminated) readings, or directly as a setup of three aforementioned wires for unfiltered output. Exemplary embodiments are illustrated in FIG. 10 and FIG. 11.

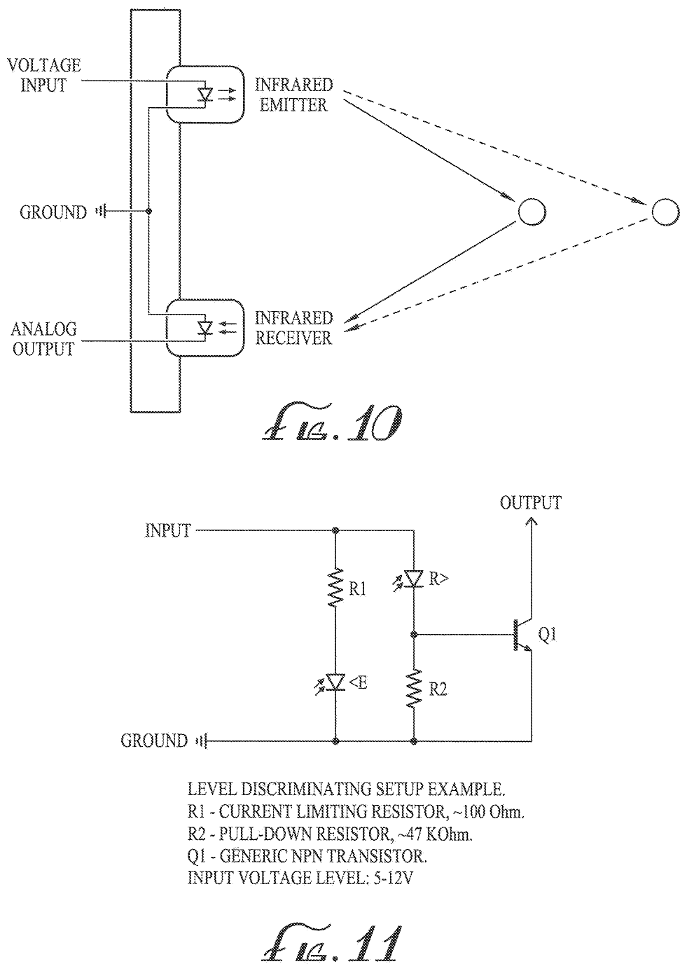

FIG. 9 illustrates another cross section view of the embodiment in FIG. 8. The shoulder trigger button 80 with the piston 84 is adjacent to the tube 82. The spring 32 is placed within the tube 82 and in this embodiment, the spring 32 is compressed by the user activating or pushing the shoulder trigger button 80 (shown by the arrow in FIG. 9) so that the piston 84 is displaced within the tube 82.

As shown in FIG. 9, the piston 84 is secured to the rod 30 and the rod 30 recedes further within the rod sleeve 34. The spring bumper 36 is placed within the tube 82 and contacts the spring 32 as shown in FIG. 9. The rod sleeve platform 40 with the light emitter 42 and light receiver 44 are secured within the tube 82.

In this embodiment, light illustrated by the dashed line 90 in FIG. 9, is emitted from the light emitter 42 toward the reflecting surface 26 and then reflected toward the light receiver 44 also as illustrated by dashed line 90. The light receiver receives the light (dashed line 90). The spring 32 and spring bumper 36 are arranged within the tube 82 to not interfere with the light as shown in FIG. 9.

The light receiver 44 is connected to an analog sensor that calculates the delay and beam intensity to determine the piston location or distance illustrated as D4 in FIG. 9. Shorter distance D4 results in higher intensity of reflect light, which results in greater analog readings on the receptable or receiving piece of the setup that incrementally grow as the distance becomes shorter and conversely, recede as the piston 84 is moved further away. This is illustrated graphically in an approximate manner in FIG. 12.

While the present invention has been described with regards to particular embodiments, it is recognized that additional variations of the present invention may be devised by persons skilled in the art without departing from the inventive concepts disclosed herein and the invention is entitled to the full breadth and scope of the claims.

What is claimed is:

1. An optical button system comprising:
a trigger button;
a piston engaged with the trigger button, the piston having a light reflecting surface and operably engaging a spring within a closed ended tube, the tube sized to accommodate the piston so that the piston is displaced in a plurality of positions within the tube by operation of the trigger button;
a light emitter and a light receiver within the tube operably opposed to the light reflecting surface of the piston and positioned so that light from the light emitter is reflected by the first reflecting surface of the piston to the light receiver,
so that by selectively displacing the piston within the tube, the light from the light emitter is reflected to the light receiver, the light receiver operably connected to a processor to calculate the light delay and light intensity to determine the proximity of the piston and generate control commands related to one or more positions of the piston.

2. The optical button system of claim 1 comprising a spring bumper within the tube, the spring bumper operably engaged with the spring and including one or more apertures to allow the light from the light emitter to transmit to the light reflecting surface and then reflect from the light reflecting surface to the light receiver.

3. The optical button system of claim 1 incorporated into a video game controller.

4. An optical signal measurement apparatus to activate input commands for an electronic device comprising:
a trigger button;
a piston connected to the trigger button, the piston having a first reflecting surface and operably engaging a spring within a closed ended tube, the tube sized to accommodate the piston and the first reflecting surface of the piston so that the piston is displaced in a plurality of positions within the tube by a user actuating the trigger button;
a light emitter and a light receiver arranged within the tube opposite the first reflecting surface of the piston and positioned so that light from the light emitter is reflected by the first reflecting surface of the piston to the light receiver,
so that when the piston is displaced within the tube, the light from the light emitter is reflected to the light receiver, the light receiver being operably connected to a sensor and controller to utilize the received reflected light to generate one or more input commands related to the positions of the piston.

5. The optical signal measurement apparatus of claim 4 incorporated into a video game controller.
